(19) United States
(12) Patent Application Publication
(10) Pub. No.: US 2006/0152856 A1
(43) Pub. Date: Jul. 13, 2006

(54) Short-tail head gimbal assembly testing fixture

(76) Inventors: Yangguo Zhao, Dongguan City (CN); Siukei Wong, Tsing Yi (CN)

Correspondence Address: KENYON & KENYON LLP, RIVERPARK TOWERS, SUITE 600, 333 W. SAN CARLOS ST., SAN JOSE, CA, 95110, US

(21) Appl. No.: 11/210,211

(22) Filed: Aug. 22, 2005

(30) Foreign Application Priority Data
Jan. 10, 2005 (WO) PCT/CN05/00032

(51) Int. Cl. G11B 5/48

(52) U.S. Cl. 360/264.2

(57) ABSTRACT

A method and system for testing the read/write head's dynamic electrical performance on an HGA level is disclosed. A head gimbal assembly (HGA) testing system has a spin stand holding a hard disk and a tester to send test signals through an HGA. The tester sends its signals through a pre-amplifier board. The pre-amplifier board is connected to the HGA using a probe card. A set of one or more pogo pins electrically connects the pre-amplifier board to the probe card. The probes of the probe card may be at a pre-determined pitch from the pogo pins.

### BACKGROUND INFORMATION

The present invention is directed to head gimbal assemblies. More specifically, the present invention pertains to a tester to test the read/write head's dynamic electrical performance on a head gimbal assembly level.

FIG. 1 illustrates a hard disk drive design typical in the art. Hard disk drives 100 are common information storage devices consisting essentially of a series of rotatable disks 104 that are accessed by magnetic reading and writing elements. These data transferring elements, commonly known as transducers, are typically carried by and embedded in a slider body 110 that is held in a close relative position over discrete data tracks formed on a disk to permit a read or write operation to be carried out. The slider is held above the disks by a suspension. The suspension has a load beam and flexure allowing for movement in a direction perpendicular to the disk. The suspension is rotated around a pivot by a voice coil motor to provide coarse position adjustments. A micro-actuator couples the slider to the end of the suspension and allows fine position adjustments to be made.

In order to properly position the transducer with respect to the disk surface, an air bearing surface (ABS) formed on the slider body 110 experiences a fluid air flow that provides sufficient lift force to “fly” the slider 110 (and transducer) above the disk data tracks. The high speed rotation of a magnetic disk 104 generates a stream of air flow or wind along its surface in a direction substantially parallel to the tangential velocity of the disk. The air flow cooperates with the ABS of the slider body 110 which enables the slider to fly above the spinning disk. In effect, the suspended slider 110 is physically separated from the disk surface 104 through this self-actuating air bearing. The ABS of a slider 110 is generally configured on the slider surface facing the rotating disk 104 (see below), and greatly influences its ability to fly over the disk under various conditions.

FIG. 2a illustrates a micro-actuator with a U-shaped ceramic frame configuration 201. The frame 201 is made of, for example, Zirconia. The frame 201 has two arms 202 opposite a base 203. A slider 204 is held by the two arms 202 at the end opposite the base 203. A strip of piezoelectric material 205 is attached to each arm 202. A bonding pad 206 allows the slider 204 to be electronically connected to a controller. FIG. 2b illustrates the head gimbal assembly (HGA) micro-actuator as attached to an actuator suspension flexure 207 and load beam 208. The micro-actuator can be coupled to a suspension tongue 209. Traces 210, coupled along the suspension flexure 207, connect the strips of piezoelectric material 205 to a set of connection pads 211. Voltages applied to the connection pads 211 cause the strips 205 to contract and expand, moving the placement of the slider 204. Read and write signals are also sent via the connection pads 211 to the slider 204. The suspension flexure 207 can be attached to a base plate 212 with a hole 213 for mounting on a pivot via a suspension hinge 214. A tooling hole 215 facilitates handling of the suspension during manufacture and a suspension hole 216 lightens the weight of the suspension.

FIG. 3a in a perspective view and FIG. 3b in an expanded view illustrate a prior art head gimbal assembly (HGA) testing system. The HGA testing system has a disk chuck 302 and a preamplifier board 304. The disk chuck 302 is mounted on a spindle motor 306. The preamplifier board 304 is connected to an electronic read/write analysis system. The hard disk 308 is positioned on the spindle chuck 302 by abase ring 310 and atop ring 312. A cap 314 and lock screw 316 hold the hard disk 308, the base ring 310 and the top ring 312 in place on the spindle chuck 302. HGA 318 with the slider facing upwards is mounted on a mounting block 320 coupled to a fixture cartridge. The pre-amplifier board 304, held by a holder 322, has a set of pogo pins 324 soldered to it. The pogo pins 324 are pressed against a set of test pads 326 on the HGA 318, creating an electrical connection.

The mounting block 320, part of a fixture cartridge with a HGA 318 from a flowing tray, is placed on the tester to write to and read from the hard disk 308. The slider is loaded into position on the bottom of the hard disk 308 using a specially designed loading and unloading mechanism. The spin stand may then rotate the disk 308 using the spindle chuck 302 during testing. When the testing is completed, the tester will automatically drive off to the home position. The fixture cartridge with mounting block 320 is taken off the tester and the HGA 318 is unloaded to the flow tray.

The hard disk 308 has an inner diameter 328 and an outer diameter 330 test zone. The above apparatus is mainly effective for testing the inner diameter zone 328 through simulation, and is also effective for testing the outer diameter zone 330. The outer diameter zone 330 does not require simulation. The simulation method tests at the outer diameter 330 zone location. To keep the outer diameter 330 zone test position's linear speed in inches/second (IPS) and kilo flux change per inch (KFCI) the same as an actual inner diameter 328 zone test position, the KFCI must equal twice the test high frequency in Hertz divided by the IPS. The IPS is equal twice pi times the radius times the rotations per minute divided by 60.

The above apparatus is used for testing the read/write head's dynamic electrical performance on an HGA level, and is suitable for all sizes of disk, such as 0.85 inches, 1 inch, 1.8 inches, 2.5 inches, and 3.5 inches. As the pogo pins 324 will hit the hard disk 308 and be damaged while moving to the inner diameter 328, the tester can only test the up-head or down-head position at a time. Also, the simulation rotations per minute at the outer diameter 330 is lower than normal inner diameter testing, increasing testing time.

### BRIEF DESCRIPTION OF THE DRAWINGS

FIG. 1 illustrates a hard disk drive design typical in the art.

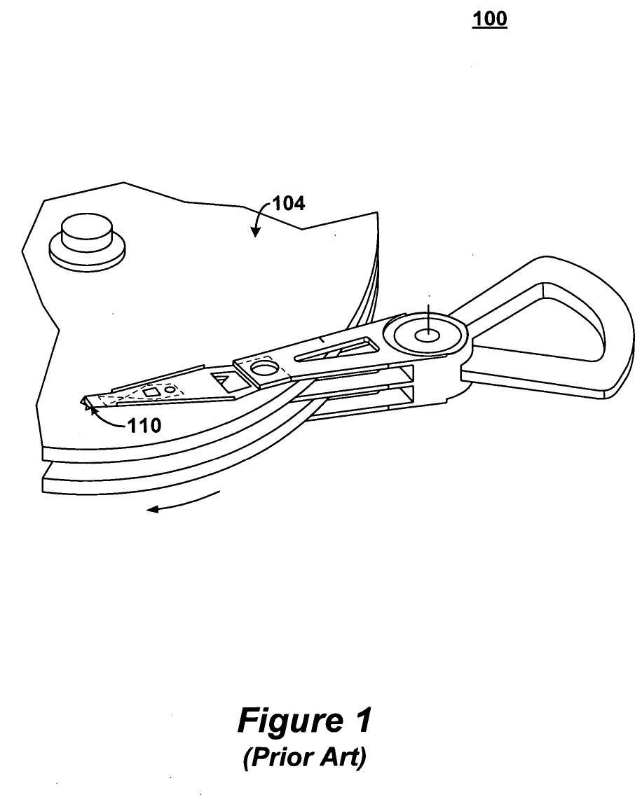

FIGS. 2a-b illustrate a typical head gimbal assembly having a U-shaped micro-actuator.

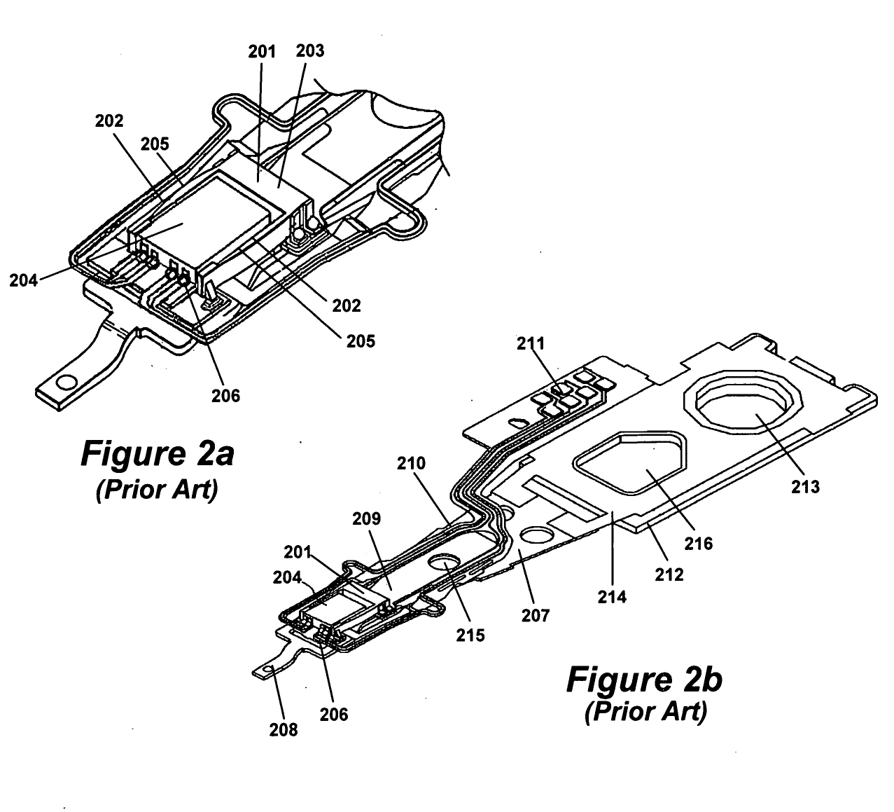

FIGS. 3a-b illustrate a prior art head gimbal assembly (HGA) testing system.

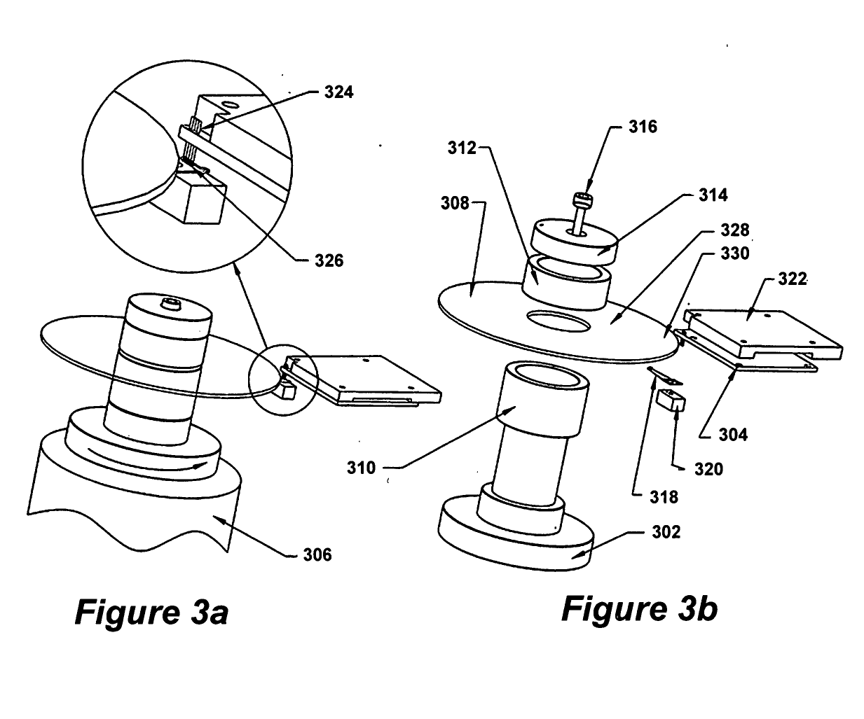

FIGS. 4a-b illustrate an HGA testing system according to an embodiment of the present invention.

FIGS. 5a-b illustrate of a tester fixture structure according to an embodiment the present invention.

FIGS. 6a-c illustrate a probe card according to an embodiment of the present invention.

FIGS. 7a-c illustrate an alternate embodiment of a probe card according to the present invention.

FIGS. 8a-b illustrate the HGA testing connection system during the testing process according to an embodiment of the present invention.

FIGS. 9a-b illustrate one embodiment of a HGA testing system according to the present invention.

FIG. 10 illustrates in a flowchart a method for testing the HGA according to an embodiment of the present invention.

### DETAILED DESCRIPTION

A method and system for testing the read/write head's dynamic electrical performance on a head gimbal assembly (HGA) level is disclosed. An HGA testing system has a spin stand holding a hard disk and a tester to send test signals through an HGA. The tester sends its signals through a pre-amplifier board. The pre-amplifier board is connected to the HGA using a probe card. A set of one or more pogo pins electrically connects the pre-amplifier board to the probe card. The probes of the probe card may be at a pre-determined pitch from the pogo pins.

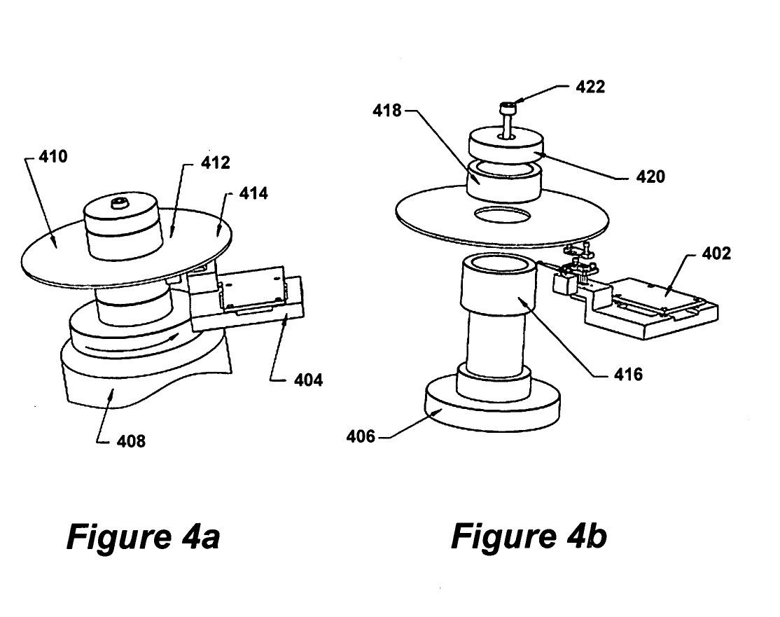

FIG. 4a in a perspective view and FIG. 4b in an expanded view illustrate one embodiment of an HGA testing system according to the present invention. The HGA testing system has a pre-amplifier board 402 mounted on a holder 404 and a disk chuck 406 mounted on a spindle motor 408. The hard disk 410 is mounted onto a disk chuck 406. In one embodiment, the disk chuck 406 rotates the disk 410 in a counter-clockwise direction. The hard disk 410 has an inner diameter testing zone 412 and an outer diameter testing zone 414. The hard disk 410 is positioned on the spindle chuck 406 by a base ring 416 and a top ring 418. A cap 420 and lock screw 422 hold the hard disk 410, the base ring 416, and the top ring 418 in place on the spindle chuck 406.

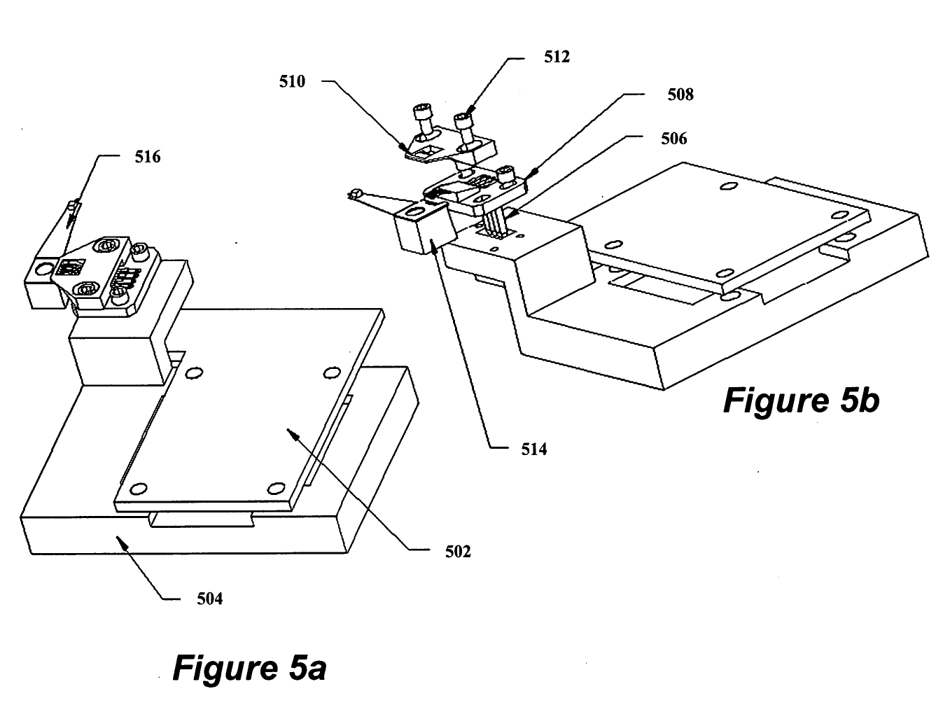

FIG. 5a in a perspective view and FIG. 5b in an expanded view illustrate one embodiment of the fixture with a preamplifier 502 according to the present invention. A pre-amplifier board 502 is mounted to a holder 504. A set of one or more pogo pins 506 is soldered onto the pre-amplifier board 502. A probe card 508 is mounted to the holder 504 so that the pogo pins 506 are in contact with pads on the back side of the probe card 508. In one embodiment, a cover 510 is affixed by lock screws 512 to protect the probe card 508 from damage caused by the rotary hard disk 410. A mounting block 514 of a fixture cassette holds an HGA 516 in a position where it may be electrically connected to the probe card 508. In one embodiment, the HGA 516 is a short tail HGA and is mounted on the mounting block 514 with the slider facing up.

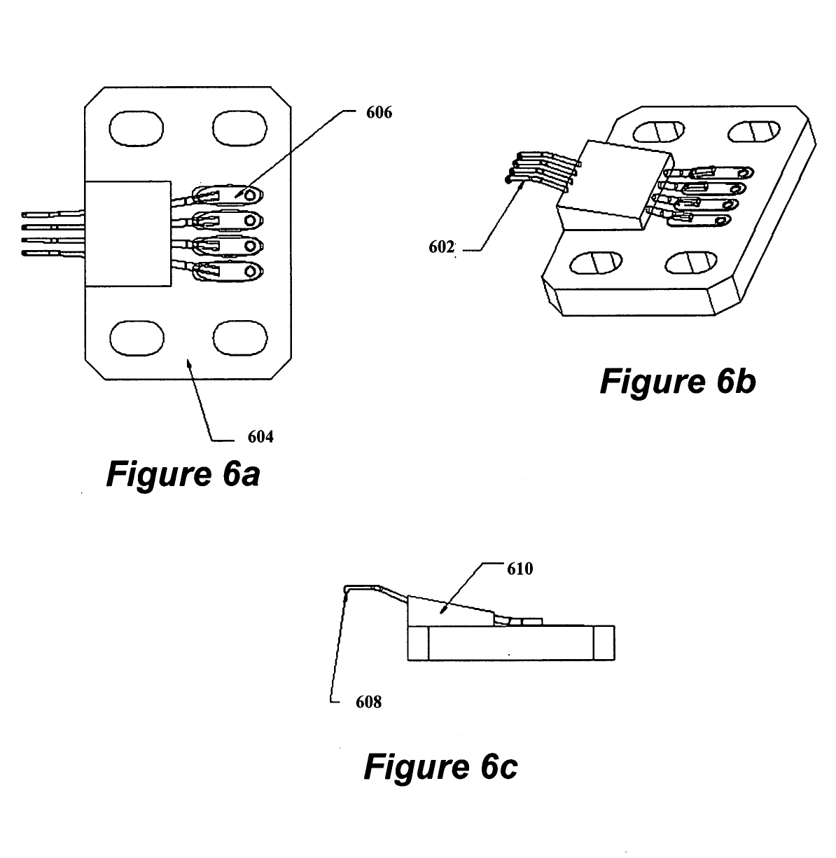

FIG. 6a in a top view, FIG. 6b in a side view, and FIG. 6c in a perspective view illustrate one embodiment of a probe card 508 according to the present invention. The probe card 508 has a set of one or more probes 602 coupled to a printed circuit board (PCB) 604. The probes 602 are electrically coupled to a set of one or more bonding pads 606 on the top of the PCB 604. In one embodiment, the probes 602 are coupled to the bonding pads 606 by solder. The bonding pads 606 are electrically connected to a set of one or more contact pads (not shown) on the reverse side of the PCB 604. The contact pads electrically connect the pogo pins 506 of the pre-amplifier board 502 to the probes 602. Alternately, a flexible printed circuit may connect the bonding pads 606 to the pre-amplifier board 502. In one embodiment, the probes 602 each have a contact tip 608 at the end of the probe 602 that will be in contact with test pads of the HGA 516. The probes 602 are held at a pre-determined pitch by an epoxy mount 610.

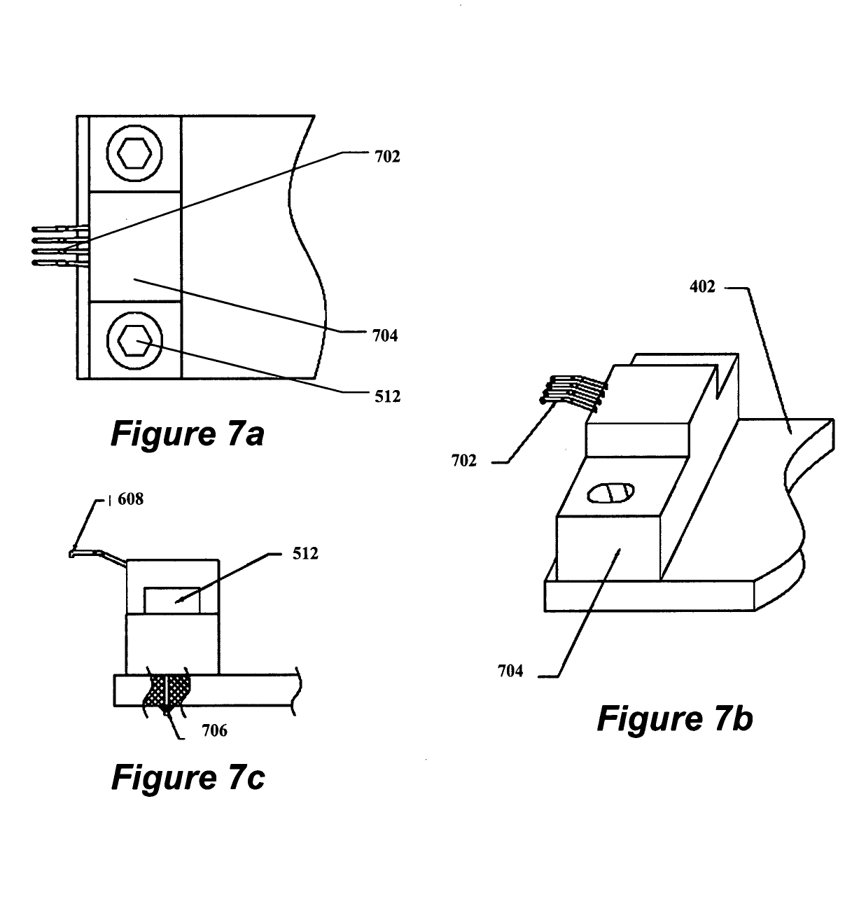

FIG. 7a in a top view, FIG. 7b in a side view, and FIG. 7c in a perspective view illustrate an alternate embodiment of a probe card 508 according to the present invention. In one embodiment, the probes 702 are double-ended probes to create an electrical connection between the preamplifier board 502 and the HGA 516. The probes 602 are held at a pre-determined pitch by a probe housing 704. The other ends of the probes are soldered 706 to the preamplifier board 502.

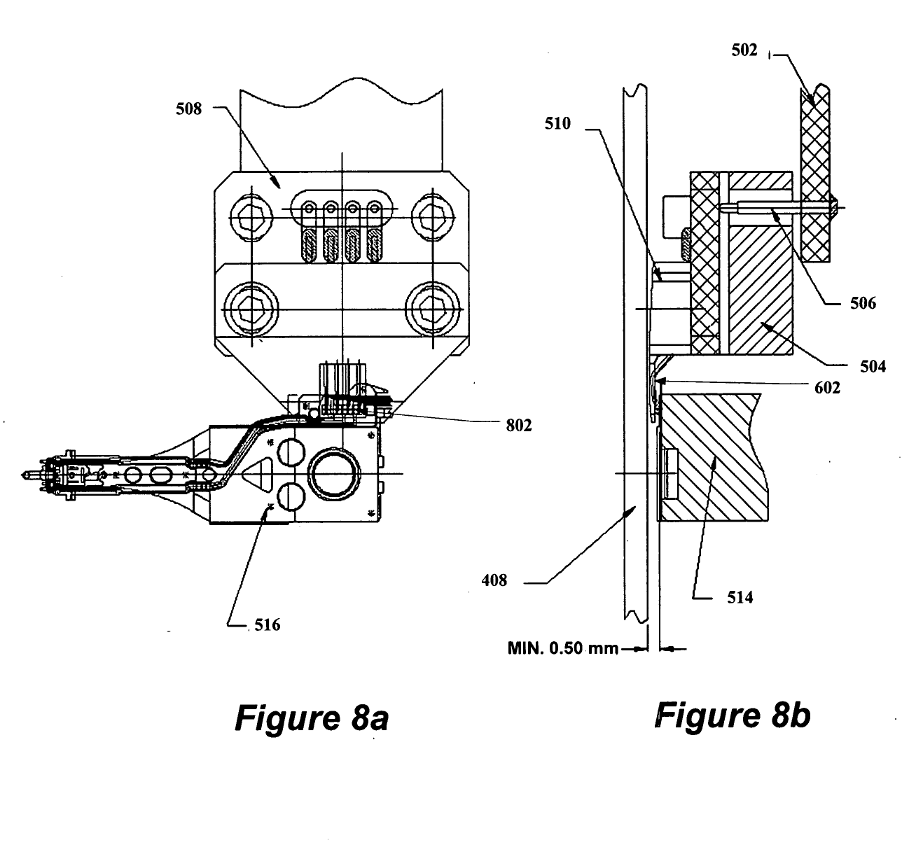

FIG. 8a in a top view and FIG. 8b in a cross-section illustrate one embodiment of the HGA testing connection system during the testing process according to the present invention. In one embodiment, the HGA mounting block 514 holds the HGA 516 with at least 0.50 mm from the surface of the hard disk 410 to the surface of the HGA test pads 802. The holder 504 holds the pre-amplifier board 502 and the probe card 508 in place. The pogo pins 506 electrically connect the pre-amplifier board 502 to the probe card 508. The cover 510 protects the probe card 508 from damage by the hard disk 408. The probes 602 of the probe card 508 create an electrical connection between the probe card 508 and the test pads 802 of the HGA 516, allowing testing operations to be run using the HGA 516.

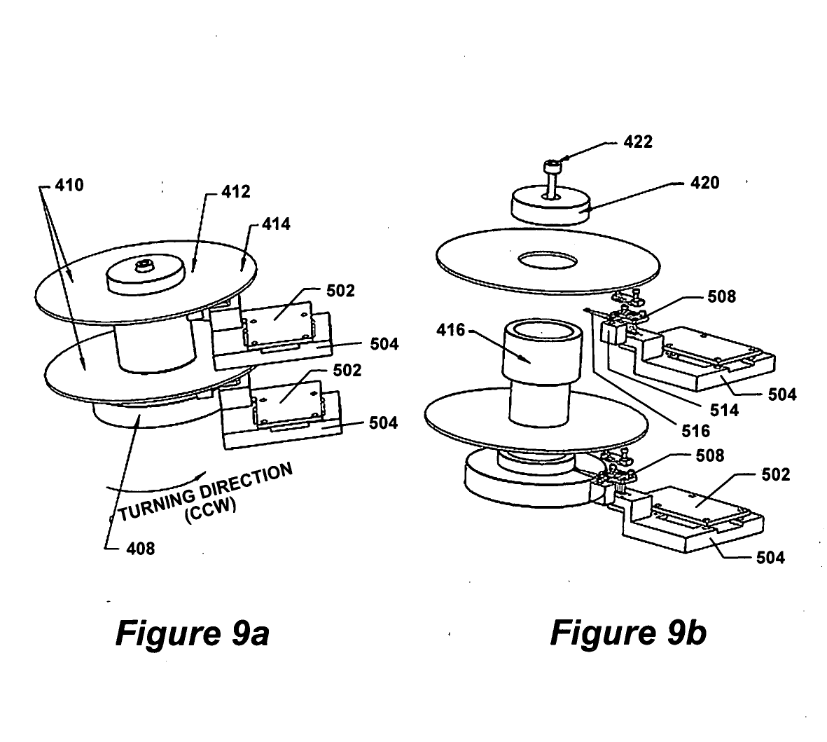

FIG. 9a in a perspective view and FIG. 9b in an expanded view illustrate one embodiment of a HGA testing system according to the present invention. Multiple fixture cartridges each with a mounting block 514 may be assembled with multiple probe cards 508 each connected to a pre-amplifier board 502 to allow multiple head gimbal assemblies 516 to be tested on a set of disks 410 on a single disk chuck 408 simultaneously.

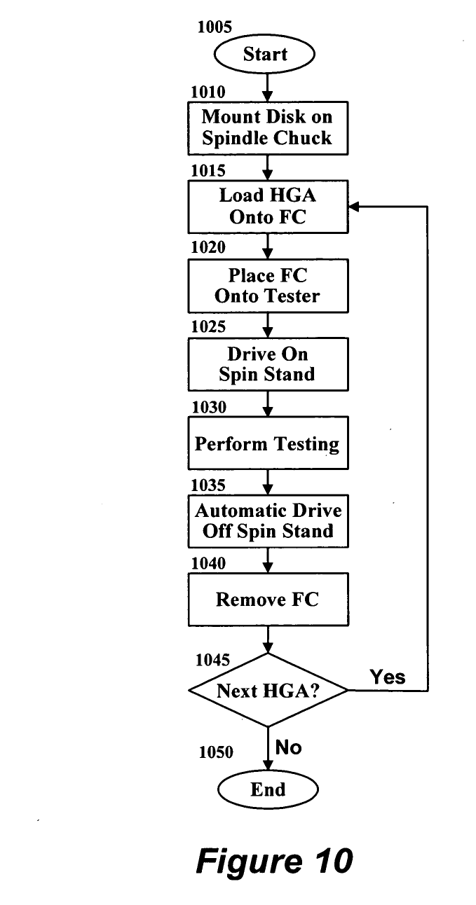

FIG. 10 illustrates in a flowchart one embodiment of a method for testing the HGA according to the present invention. The process starts (Block 1005) by mounting a hard disk 410 onto the disk chuck 408 (Block 1010). The HGA 516 is taken from a flow tray and loaded onto the mounting block 514 of a fixture cartridge (FC) (Block 1015), bringing the test pads 802 of the HGA 516 into contact with the probes 602 of the probe card 508. The fixture cartridge is placed onto the tester (Block 1020). The tester is then driven onto the tester's mechanical system (Block 1025). Testing the read/write head's dynamic electrical performance on an HGA level is performed (Block 1030). The tester is then automatically driven off the spin stand 404 (Block 1035). The fixture cartridge is then removed from the tester and the HGA 516 is taken off of the mounting block 518 (Block 1040). If a new HGA is available (Block 1045), then a new HGA is taken off the flow tray and the new HGA is mounted onto a fixture cartridge (Block 1015). Otherwise, the process is ended (Block 1050).

What is claimed is:

1. A test probe card, comprising:
a set of one or more bonding pads to be electrically coupled to a preamplifier by a set of one or more pogo pins;
a set of one or more probes to provide electrical contact with a head gimbal assembly; and
a printed circuit board to electrically couple the one or more bonding pads to the one or more probes.

2. The test probe card of claim 1, wherein the set of one or more probes are at a pre-determined pitch to the pogo pins.

3. The test probe card of claim 2, further comprising an epoxy mount to hold the set of one or more probes at the predetermined pitch.

4. The test probe card of claim 1, wherein a cover protects the set of one or more probes.

5. A head gimbal assembly (HGA) testing system, comprising:
a hard disk to store data;
a spindle chuck to support the hard disk;
a mounting block to support a head gimbal assembly in a position to read and write data to and from the hard disk;
a test probe card with a set of one or more probes to provide electrical contact with the head gimbal assembly; and
a preamplifier to transmit signals to and receive signals from the head gimbal assembly via the test probe card.

6. The HGA testing system of claim 5, wherein the test probe card has a set of one or more double ended probes to electrically couple the set of one or more probes to the preamplifier.

7. The HGA testing system of claim 5, further comprising a set of one or more pogo pins to electrically couple the set of one or more probes to the preamplifier.

8. The HGA testing system of claim 7, wherein the set of one or more probes are at a pre-determined pitch to the pogo pins.

9. The HGA testing system of claim 8, wherein the test probe card has an epoxy mount to hold the set of one or more probes at the predetermined pitch.

10. The HGA testing system of claim 5, further comprising a cover to protect the set of one or more probes.

11. The HGA testing system of claim 5, wherein multiple mounting blocks support multiple head gimbal assemblies in a position to read and write data to and from multiple hard disks and multiple test probe cards provide electrical contact with the multiple head gimbal assemblies simultaneously.

12. The HGA testing system of claim 5, wherein the head gimbal assembly is loaded and unloaded automatically.

13. A method, comprising:
supporting a head gimbal assembly in a position to read and write data to and from a hard disk;
using a test probe card with a set of one or more probes to provide electrical contact between the head gimbal assembly and a set of one or more pogo pins electrically coupled to a pre-amplifier board;
transmitting signals to the head gimbal assembly via the test probe card; and
receiving signals from the head gimbal assembly via the test probe card.

14. The method of claim 13, wherein the set of one or more probes are at a pre-determined pitch to the pogo pins.

15. The method of claim 14, further comprising using an epoxy mount to hold the set of one or more probes at the predetermined pitch.

16. The method of claim 13, further comprising protecting the set of one or more probes with a cover.

17. The method of claim 13, further comprising:
supporting multiple head gimbal assemblies in a position to read and write data to and from multiple hard disks on a single spindle chuck simultaneously;
using multiple test probe cards provide electrical contact with the head gimbal assembly transmitting signals to the multiple head gimbal assemblies via the test probe card simultaneously; and
receiving signals from the multiple head gimbal assemblies via the test probe card simultaneously.

18. The method of claim 13, further comprising loading and unloading the head gimbal assembly automatically.

19. The method of claim 13, further comprising using a spindle chuck to support the hard disk.
